(19) United States
(12) Patent Application Publication
(10) Pub. No.: US 2023/0280762 A1
(43) Pub. Date: Sep. 7, 2023

(54) AUTONOMOUS VEHICLE-BASED MISSION PLANNING AND AUTONOMY SYSTEM FOR MULTI-ASSET COLLABORATIVE OPERATIONS

(71) Applicant: Rockwell Collins, Inc., Cedar Rapids, IA (US)

(72) Inventors: Bryan M. Krawiec, Ashburn, VA (US); Jason J. Jakusz, Nixa, MO (US); Joel J. Fuster, Panama City, FL (US); Daniel K. Papke, Marion, IA (US)

(21) Appl. No.: 17/704,793

(22) Filed: Mar. 25, 2022

Related U.S. Application Data
(63) Continuation-in-part of application No. 17/684,095, filed on Mar. 1, 2022.

(51) Int. Cl. G05D 1/02; G05D 1/00

(52) U.S. Cl. CPC G05D 1/0295; G05D 1/0088

(57) ABSTRACT

A system and method for multi-asset collaborative operations by a team of autonomous vehicles (AV) implements a multi-level hierarchical mission planning and autonomy stack aboard each member AV of the team. Mission-level and team-level layers of the stack, either independently or in collaboration with other members of the AV team. receive high-level mission goals, spawn mission objectives for the fulfillment of received goals, and assign the mission objectives to specific member AVs or sub-teams thereof. Asset-level action planning modules translate the assigned mission objectives into default trajectories including component action and payload sequences for execution by the AV. An asset-level guidance playbook executes the default trajectories via high-rate control commands directly to vehicle and payload control systems. An asset-level avoidance control module detects threats or constraints not accounted for by mission data, overriding control commands when necessary to evade threats without disrupting higher-level mission goals or objectives.

### CROSS-REFERENCE TO RELATED APPLICATIONS

The present application is related to and claims the benefit of the earliest available effective filing dates from the following listed applications (the “Related Applications”) (e.g., claims earliest available priority dates for other than provisional patent applications (e.g., under 35 USC § 120 as a continuation in part) or claims benefits under 35 USC § 119(e) for provisional patent applications, for any and all parent, grandparent, great-grandparent, etc. applications of the Related Applications).

### RELATED APPLICATIONS

U.S. patent application Ser. No. 17/684,095 filed Mar. 1, 2022 and entitled HIGH FIDELITY TEAMMATE STATE ESTIMATION FOR COORDINATED AUTONOMOUS OPERATIONS IN COMMUNICATIONS DENIED ENVIRONMENTS;

Concurrently filed U.S. patent application Ser. No. ______ having attorney docket number 133435US01 and entitled SYSTEM AND METHOD FOR GUIDANCE INTEGRITY MONITORING FOR LOW-INTEGRITY MODULES; and

Concurrently filed U.S. patent application Ser. No. ______ having attorney docket number 133442US01 and entitled COLLABORATIVE SEARCH MAPPING FOR AUTONOMOUS MULTI-ASSET TEAMS.

Said U.S. patent application Ser. No. 17/684,095; ______ ((133435US01); and Ser. No. ______ ((133442US01) are herein incorporated by reference in their entirety.

### BACKGROUND

Autonomous vehicle (AV) technology is advancing rapidly in both capability and complexity. In military or civilian applications, land-based, air-based, or sea-based AVs perform tasks that are conventionally performed by human operators (e.g., search/rescue, surveillance, target acquisition, reconnaissance, munition strikes), reducing the risk of bodily harm to military personnel. Full-scale mission autonomy, e.g., the fulfillment of a particular mission (which may be selected by a human operator but executed by an autonomous asset or team thereof), requires end-to-end decision making by the asset or team with minimal operator intervention.

### SUMMARY

In a first aspect, an autonomous vehicle (AV)-based mission planning and autonomy system for multi-asset collaborative operations is disclosed. In embodiments, the AV is a member of a team comprising the AV (e.g., ownship AV) and additional teammate AVs, each AV of the team including a controller and communications system for information sharing among member AVs. For example, each controller is in communication with vehicle/flight control, communications, and payload control systems aboard its respective AV, and includes processors and a memory for storage of mission data and processor-executable instructions. Also stored to memory is a hierarchical mission planning and autonomy stack comprising a mission-level coordination module, team planning module, asset-level planning module, control and guidance module, and/or avoidance control module. In embodiments, the mission-level coordination module receives high-level mission commands associated with the fulfillment of a mission by the AV team. Based on the received mission commands, the mission-level coordination module (either individually or collaboratively between member AVs) generates an occupancy map for monitoring mission fulfillment and spawns mission objectives for completion by the member AVs. In embodiments, the team planning module (either individually or collaboratively) assigns the spawned mission objectives to specific member AVs or sub-teams for completion. In embodiments, the asset-level planning module aboard each member AV generates specific action plans (e.g., default trajectories, action and control sequences) for execution by that member AV toward the completion of its assigned objectives. In embodiments, the control and guidance module executes the generated action plans and default trajectories (e.g., sequences of pre-programmed guidance/control actions from a “guidance playbook”) by issuing high-rate control commands to flight and/or payload control systems (e.g., commands issued with at least a minimum rate of frequency). In embodiments, the avoidance control module monitors the current state of the AV (e.g., position, velocity, time, mission objective completion, payload status) and detects threats (e.g., to the mission or to the AV) that may not be associated with existing mission data. For example, the avoidance control module may evade detected threats without disturbing the current mission objectives or action plans by overriding selected control commands.

In some embodiments, the members AVs include aerial vehicles, water-based vehicles, and/or ground-based vehicles.

In some embodiments, mission data and mission commands received by the mission-level coordination module include mission types, team sizes, operating areas/volumes and/or regions thereof, specific features of operating areas or regions, or configuration preferences.

In some embodiments, configuration preferences include prioritizations of the received mission objectives, e.g., according to a desired behavior or behavior trait of the AV.

In some embodiments, the mission-level coordination module monitors the occupancy map (e.g., individually or collaboratively) by adjusting a mission fulfillment status, a mission objective completion status, a state of the operating area, and/or a state of one or more regions thereof.

In some embodiments, the mission-level coordination module monitors the occupancy map in collaboration with additional AV teams.

In some embodiments, the team planning module reassigns or modifies mission objectives in response to a contingency affecting the AV team (e.g., attrition of a member AV, addition of a new team member AV, changes in high-level mission goals).

In some embodiments, control commands issued by the guidance and control module cause the vehicle or flight control system to adjust one or more of a heading of the AV, an altitude of the AV, a velocity of the AV, a climb rate of the AV, or a descent rate of the AV.

In some embodiments, the payload may include cameras for capturing images across a variety of operating wavelengths or spectra, sensors for passive detection of RF emissions or reflected radar beams, and/or munitions for deployment.

In some embodiments, detected threats may include an adversarial or hostile structure, an adversarial vehicle, and/or an adversarial weapon.

In some embodiments, the avoidance control module may override control commands based on the detection of one or more of a potential collision, a keep-in zone, and/or a keep-out zone (e.g., geofence).

In a further aspect, a method for vehicle-based multi-asset autonomous collaborative operations among a team including an autonomous vehicle (AV) and one or more teammate AVs (e.g., assets) is also disclosed. In embodiments, the method includes receiving, via a mission receiving, via a mission-level coordination module of the AV, mission data associated with at least one mission to be fulfilled by the team, the mission data including high-level mission commands and goals. The method includes generating, via the mission-level coordination module and based on the received high-level mission goals, 1) an occupancy map for monitoring mission fulfillment and 2) mission objectives toward the fulfillment of high-level mission goals. The method includes assigning, via a team planning module of the AV, the spawned mission objectives to specific member AVs of the team or sub-teams thereof. The mission includes selecting, via an asset-level planning module of the AV, default trajectories (e.g., action plans, action and control sequences) for execution by the AV toward completion of the mission objectives assigned to the AV. The method includes executing, via a guidance and control module of the AV, the default trajectories or action plans by issuing high-rate control commands to the control systems (e.g., flight control, payload control) of the AV. The method includes detecting, via an avoidance control module of the AV, threats or constraints not provided for by the original mission data. The method includes avoiding, via the avoidance control module, any detected threats or constraints by overriding selected control commands.

In some embodiments, the method includes receiving mission data including one or more of a mission type, a team size, an operating area/volume or one or more regions thereof, a feature of an operating area or region thereof, and/or a configuration preference associated with a behavior trait of an AV or sub-team thereof.

In some embodiments, the method includes reassigning or modifying, via the team planning module, the assigned mission objectives in response to a contingency affecting the AV team. For example, the associated high-level mission goals may change, or the team membership may change via, e.g., the attrition of one or more member AVs or the addition of one or more non-member AVs to the AV team.

In some embodiments, the method includes monitoring, via the mission level coordination module (individually or collaboratively with the mission-level coordination modules of other member AVs), the occupancy map by adjusting a mission fulfillment status, a mission objective completion status, a state of the operating area or volume, and/or a state of a region or sub-region of the area or volume.

In some embodiments, the method includes notifying, via the avoidance control module, the asset-level planning module, team planning module, and/or mission-level coordination module of any overrides to issued control commands.

In some embodiments, the method includes directing the flight control system of the AV to adjust, via control commands issued by the guidance and control module, one or more of a heading of the AV, an altitude of the AV, a velocity of the AV, a climb rate of the AV, or a descent rate of the AV.

In some embodiments, the method includes detecting multiple threats or constraints via the avoidance control module, and selecting a higher priority threat or constraint to address first (via overrides issued by the avoidance control module) before addressing one or more lower priority threats or constraints. For example, configuration preferences or operator input may govern the overall behavior of the AV by prioritizing selected threats, constraints, and/or responses at the expense of others.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a diagrammatic illustration of a mission space for fulfillment of high-level mission goals by an autonomous vehicle (AV) team according to example embodiments of this disclosure;

FIG. 2 is a block diagram of an AV of the AV team of FIG. 1, implementing an onboard mission planning and autonomy system;

FIG. 3 is a diagrammatic illustration of the AV and mission planning and autonomy system of FIGS. 1 and 2; and

FIGS. 4A through 4F are flow diagrams illustrating a method for vehicle-based multi-asset collaborative operations by a member AV of an AV team according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly speaking, embodiments of the inventive concepts disclosed herein are directed to a decentralized, coordinated mission planning and autonomy system distributed across a team of two or more autonomous vehicles (AV). For example, the mission planning and autonomy system accepts as input one or more high-level mission goals and provides as output targeted high-rate platform commands to each member AV of the team in fulfillment of desired mission goals. Detailed planning, coordination, and control of mission operations is accomplished by a hierarchy of system layers running on each team member platform and providing mission-level, team-level, and asset-level decision-making. Accordingly, teams of AVs can carry out complex missions via sequences of intuitive and explainable actions. System components are reusable, replaceable, and modular.

The decentralized and distributed design of the mission planning and autonomy system enables scaling up or down to any team size while providing seamless addition or attrition of assets to or from the team. Contingencies not accounted for by the mission plan may be responded to at the asset, team, or mission level. A “playbook”, or bank of guidance and control actions, allows for modular sequencing of operations to suit a broad variety of mission objectives and provides for both horizontal and vertical information sharing.

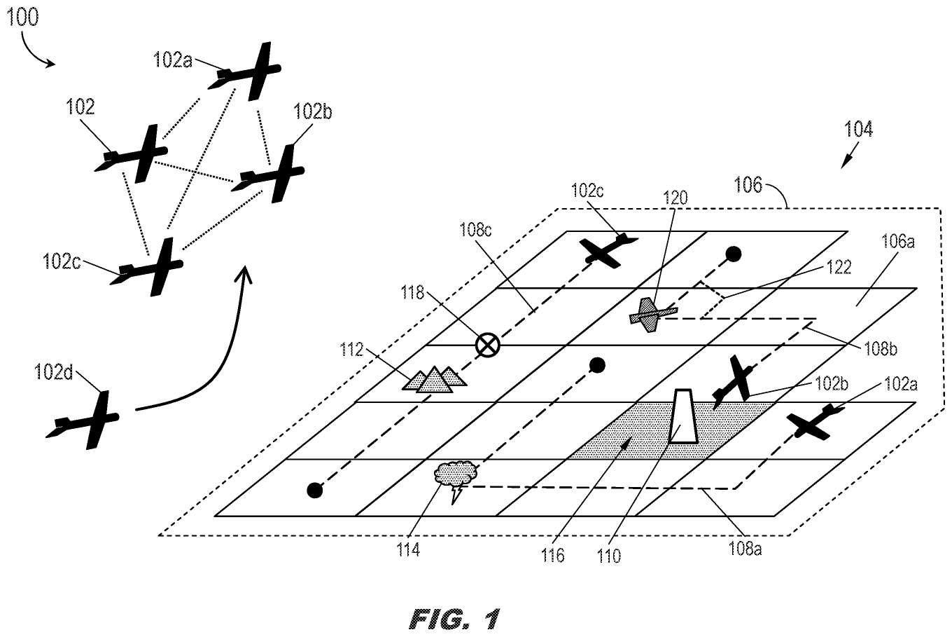

Referring to FIG. 1, an autonomous vehicle (AV) team 100 is disclosed. The AV team 100 may include an autonomous vehicle 102 (AV; e.g., ownship AV) and one or more teammate autonomous vehicles 102a-102c (e.g., teammate AV). The members of the AV team 100, e.g., the AV 102 and teammate AVs 102a-102c, may comprise any combination of aerial vehicles (e.g., unmanned aircraft systems (UAS), unmanned aerial vehicles (UAV)), ground-based vehicles, and/or water-based vehicles.

In embodiments, the AV team 100 may be charged with fulfillment of one or more missions within a defined mission space 104, e.g., an operating area and/or a volume over the operating area (e.g., beneath a predetermined operating ceiling). For example, a mission may comprise the fulfillment of one or more high-level mission goals by an AV team 100 of a defined size, e.g., the AV 102 and the three teammate AVs 102a-102c. High-level mission goals may comprise a variety of military or civilian mission types, e.g., reconnaissance, surveillance, search-and-rescue, search-and-destroy, munitions strike, electronic warfare, or a combination of two or more mission types.

In embodiments, the AV team 100 may receive a set of mission data (e.g., mission instructions) defining a mission to be fulfilled within the mission space 104. For example, mission data may define the mission type, the size of the AV team 100 (e.g., four AVs including the AV 102 and teammate AVs 102a-102c), and high-level mission goals to be fulfilled by the AV team. In embodiments, high-level mission goals may be more specific than a mission type but may leave the execution of said mission goals to the discretion of the AV team 100. For example, mission data may provide that the AV team 100 perform a complete surveillance of the mission space 104 but may not specify how this surveillance is to be accomplished.

In embodiments, each member of the AV team 100, e.g., the AV 102 and the teammate AVs 102a-102c, may incorporate a mission planning and autonomy system, e.g., running on processors of a controller aboard each AV. For example, the mission planning and autonomy system may, based on the received mission data, generate an occupancy map 106 of the mission space 104 via which progress toward the fulfillment of the assigned mission goals may be monitored. Further, the mission planning and autonomy system may spawn a set of mission objectives for completion by the AV team 100, the completion of the mission objectives fulfilling the assigned high-level mission goals. For example, the occupancy map 106 may divide the mission space 104 into a group of component cells 106a, each component cell equivalent to a terrain surface to be surveilled by an airborne member of the AV team 100. In embodiments, the number of component cells 106a defined within the occupancy map 106, and the size and shape of each component cell, may be determined by the mission planning and autonomy system for optimal surveillance of the mission space 104 by the AV team 100 according to configuration preferences defined by the mission data. At the mission coordination level, the fulfillment of high-level mission goals (and, e.g., any revision of said mission goals based on contingencies not accounted for by the mission data) may be achieved collaboratively by the mission planning and autonomy systems running aboard each member of the AV team 100 (e.g., the AV 102 and teammate AVs 102a-102c) or in collaboration with additional AV teams (not shown) assigned to the same high-level mission goals.

In embodiments, configuration preferences may represent operator input, e.g., the influence of a simulated human operator on each autonomously operating member of the AV team 100. For example, configuration preferences may include a set of weighted priorities for the AV team 100 as a whole, or for one or more of its members, e.g., the AV 102 and the teammate AVs 102a-102c. Configuration preferences may prioritize the completion of certain mission objectives assigned to the AV 102 (or to any member of the AV team 100) over other mission objectives, or set general parameters for the behavior of the AV 100 in the completion of its objectives (e.g., timidness vs aggression).

In embodiments, at the team planning level, the mission planning and autonomy systems aboard each member of the AV team 100 may assign specific mission objectives spawned at the mission coordination level to specific members of the team (e.g., to the AV 102) or to sub-teams within the AV team (e.g., the teammate AVs 102b, 102c). For example, the AV team 100 may complete the mission objective of performing a complete surveillance of the mission space 104 by assigning respective default trajectories 108a-108c to each of the teammate AVs 102a-102c, while the mission planning and autonomy system aboard the AV 102 monitors the completion of the objective (e.g., which may be tracked at the mission coordination level relative to the component cells 106a of the occupancy map 106 corresponding to the mission space 104).

In embodiments, the mission planning and autonomy system aboard the AV 102 may, at the team planning level, modify objective assignments and sub-team allocations within the AV team 100 in response to contingencies not accounted for by the mission data or changes in team composition. For example, the mission data received at the mission coordination level may provide terrain and obstacle data relating to, e.g., non-objective obstacles 110 (e.g., buildings, towers, bridges, dams, terrain, other manmade features); terrain 112 (e.g., mountains, hills, canyons, valleys, rocks, bodies of water, other natural features); and/or atmospheric conditions 114 (e.g., weather systems, storms, precipitation, wind patterns). In embodiments, the default trajectories 108a-108c assigned to each teammate AV 102a-102c at the team planning level may account for this terrain and obstacle data. However, in the completion of their respective default trajectories 108a-108c, the teammate AVs 102a-102c may encounter contingencies not accounted for by mission data. For example, the teammate AV 102b on default trajectory 108b may encounter a geofence 116, e.g., a keep-out area denying entry to the teammate AV and requiring a modification of the default trajectory to exclude the geofenced component cell 106b from the surveillance. Alternatively, or additionally, the mission planning and autonomy system may, at the team planning level, revise the composition of the AV team 100 to account for the addition or attrition of member AVs. For example, the teammate AV 102c, following the default trajectory 108c, may experience a payload or system failure at point 118 rendering the teammate AV unable to complete the default trajectory.

In embodiments, the mission planning and autonomy system (e.g., aboard the AV 102 charged with monitoring completion of the assigned mission objective) may add to the AV team 100 a supplementary AV 102d. For example, the supplementary AV 102d may be initially assigned to another AV team but may have become orphaned therefrom proximate to the AV team 100. Similarly, the supplementary AV 102d (e.g., as a teammate AV of the AV team to which it was initially assigned) may be configured with payload similar to the attritted teammate AV 102c and/or capable of assuming surveillance operations in completion of the default trajectory 108c. Accordingly, in embodiments the supplementary AV 102d may elect to join the AV team 100, e.g., for the purpose of fulfilling its initially assigned mission objectives or default trajectories or for fulfilling similar mission objectives and/or default trajectories in alignment with the high-level mission goals of the AV team 100. For example, the mission planning and autonomy system aboard the AV 102 may, at the mission coordination and team planning levels, exchange any necessary mission data with the supplementary AV 102d such that the mission planning and autonomy system running aboard the supplementary AV may execute the necessary guidance and control sequences to complete the reassigned mission objective. Similarly, the two-way exchange of mission data between the supplementary AV 102d and the AV 102 may provide the mission planning and autonomy system with detailed information as to the current resources and capabilities of the supplementary AV, which may align with the collective resources and capabilities of the AV team 100 or may augment said collective resources and capabilities.

In embodiments, once the default trajectories 108a-108c have been assigned, each teammate AV 102a-102c may, via its own mission planning and autonomy system, determine the appropriate guidance and control sequences to complete their respective default trajectories. For example, each mission planning and autonomy system may, at the asset level, include a “guidance playbook”, e.g., a bank of maneuvers, formations, and other sequences via which the mission planning and autonomy system aboard each teammate AV 102a-102c can independently exercise direct control over the teammate AV, e.g., via high-rate control commands issued to the flight control, payload control, and other control systems of the AV to directly execute the maneuvers and/or payload operations necessary for completion of the assigned default trajectories 108a-108c. Each control sequence may provide for direct adjustments to the speed, heading, attitude, and/or payload (e.g., cameras, sensors, munitions) of the AV to provide direct autonomous platform steering of the AV (as opposed to, e.g., conventional waypoint-to-waypoint navigation) between states. For example, a state of the AV 102, 102a-102c may include its navigational state, e.g., a position, altitude, and/or orientation of the AV at a particular time, but may also include a status of any payload aboard the AV (e.g., active/inactive cameras or sensors, armed/unarmed munitions) and/or a status of the AV itself (e.g., fuel level, maneuverability, structural integrity, etc.).

In embodiments, once the mission planning and autonomy system aboard each member of the AV team 100 (e.g., the AV 102 and teammate AVs 102a-102d) has determined the appropriate control sequences for completion of the assigned default trajectories 108a-108c, each mission planning and autonomy system may incorporate may include avoidance control for continuous monitoring of the vehicle state of the respective AV. For example, at the avoidance control level each mission planning and autonomy system may detect any obstacles, or threats not accounted for by the mission data and determine whether said obstacles or threats may be avoided or evaded without overriding the control sequences determined at the guidance playbook level. In embodiments, identified adversarial or hostile threats may include adversarial structures or fixtures, adversarial vehicles (including adversarial AVs), and/or adversarial weapons.

In embodiments, avoidance control may override control sequences of the AV 102, 102a-102d in progress via short-term platform steering or maneuvers, if said override is determined to be necessary and/or minimally disruptive to, e.g., the mission objectives assigned to the AV and/or the higher-level mission goals assigned to the AV team 100. For example, the teammate AV 102b on default trajectory 108b may detect a proximate air vehicle 120 not accounted for by mission data. In embodiments, the mission planning and autonomy system aboard the teammate AV 102b may monitor a state of the AV across a variety of dimensions as discussed above, e.g., navigational state, payload state, structural/operational state, progress toward completion of the default trajectory 108b. Configuration preferences aboard the teammate AV 102b (e.g., determined at the team planning level) may dictate how avoidance control aboard the teammate AV responds to the proximate air vehicle (and/or other non-objective obstacles 110, terrain 112, atmospheric conditions 114 not accounted for by mission data). For example, the mission planning and autonomy system aboard the teammate AV 102b may be directed to evade the proximate air vehicle 120 in order to avoid a collision. Alternatively, in embodiments the mission planning and autonomy system aboard the teammate AV 102b may be directed to view the proximate air vehicle 120 as hostile and override current control sequences accordingly. For example, avoidance control aboard the teammate AV 102b may attempt to evade detection by the proximate air vehicle 120, or (e.g., if the teammate AV is armed) may engage the proximate air vehicle.

In embodiments, when avoidance control aboard the teammate AV 102b overrides its predetermined control sequences (e.g., by temporarily maneuvering (122) the teammate AV away from the default trajectory 108b), the avoidance control module of the mission planning and autonomy system may provide upstream feedback with respect to the override, so that the teammate AV and/or the AV team 100 as a whole may adjust AV control sequences, mission objectives assigned to the teammate AV, or even high-level mission goals if necessary. For example, at the team planning and/or mission coordination levels, the teammate AV 102b may inform the other members of the AV team 100 (e.g., the AV 102 and teammate AVs 102a, 102c) of the detected proximate air vehicle 120 and the response of the teammate AV 102b thereto.

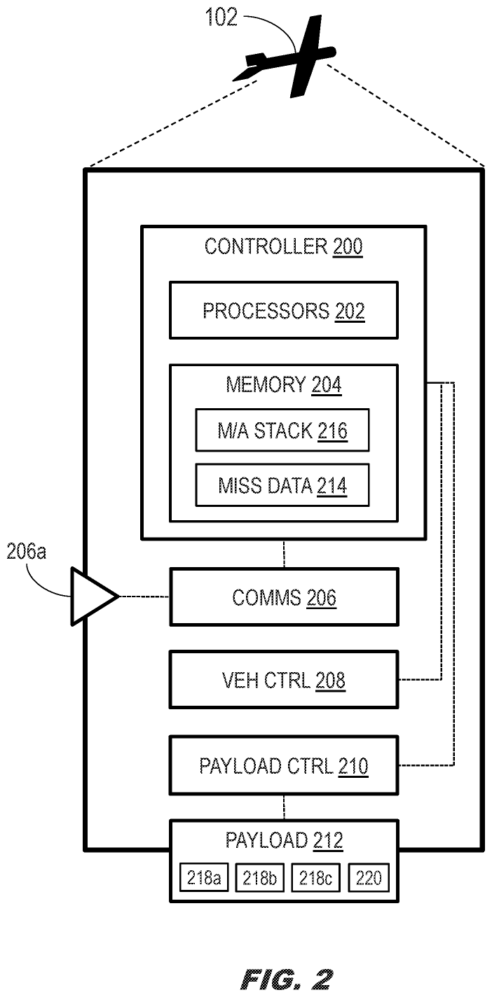

Referring to FIG. 2, the AV 102 is shown. The AV 102 may be an aerial, ground-based, or water-based vehicle. Each of the teammate AVs (102a-102c, FIG. 1) and the supplementary AV (102d, FIG. 1) of the AV team (100, FIG. 1) may be implemented and may operate similarly to the AV 102 shown by FIG. 2. The AV 102 (and, e.g., teammate AVs 102a-102c, supplementary AV 102d) may include a controller 200 (e.g., computing device), one or more processors 202, memory/data storage 204, communication device 206, vehicle control system 208, payload control system 210, and payload 212.

In embodiments, each controller 200 may be communicatively coupled to a respective communication device 206, such that each controller transmits and receives data via the respective communication device. For example, the communication device 206 may comprise one or more antennas 206a, including an RF front end, transmitter/receiver, and/or radiating elements, and may communicate in the RF frequency range. In embodiments, mission data 214 may be received and shared among the AVs 102, 102a-102d using the respective communication devices 206.

It is noted herein that, for the purposes of the present disclosure, the term “processor” or “processing element” may be broadly defined to encompass any device having one or more processing or logic elements, for example, one or more central processing units (CPUs), one or more graphics processing units (GPUs), one or more micro-processor devices, one or more application specific integrated circuit (ASIC) devices, one or more field programmable gate arrays (FPGAs), or one or more digital signal processors (DSPs). In this sense, the one or more processors 202 may include any device configured to execute algorithms and/or instructions (e.g., program instructions stored in memory), and may be configured to perform method steps described in the present disclosure. In embodiments, the memory 204 may include any storage medium known in the art suitable for storing program instructions executable by the associated one or more processors. For example, the storage medium may include, but is not limited to, a read-only memory (ROM), a random-access memory (RAM), a magnetic or optical memory device (e.g., hard disk), a magnetic tape, a solid-state drive, and the like.

In embodiments, memory 204 may also be configured to store mission data 214, including high-level mission goals received by the AV team 100, information related to the mission space (104, FIG. 1), default trajectories (108a-108c, FIG. 1) assigned to each AV 102, 102a-102c, and/or positions and geometry of, e.g., non-objective obstacles (110, FIG. 1), terrain (112, FIG. 1), and/or atmospheric conditions (114, FIG. 1). Further, the memory 204 may be configured for storage of mission objectives spawned at the team planning level and assigned to the individual AV 102 or to a sub-team within the AV team 100, e.g., including the AV 102 and one or more teammate AVs 102a-102d.

In embodiments, the memory 204 may be configured for storage of the mission planning and autonomy stack 216, e.g., encoded instructions executable by the processors 202 for implementing the mission planning and autonomy system aboard the AV 102 and in collaboration with other teammate AVs 102a-102d of the AV team 100. For example, the mission planning and autonomy stack 216 may exercise direct control over flight operations, communications operations, and/or payload operations 212 of the AV 102 by causing the processors 202 to interface with the vehicle control system 208, communications device 206, and/or payload control system 210, e.g., as provided for by the mission data 214. Further, the memory 204 may be configured for storage of any new data generated by the mission planning and autonomy stack 216 in furtherance of high-level mission goals included in the mission data 214. For example, the memory 204 may additionally store one or more of: mission objectives spawned at the mission coordination level; mission objective and sub-team assignments generated at the team planning level (e.g., including, in these first two cases, in collaboration with teammate AVs 102a-102c); guidance and control action sequences (e.g., default trajectories 108a-108c generated at the asset level in furtherance of assigned mission objectives; specific control commands generated to achieve the default trajectories at the guidance playbook level; and/or any overrides of the control commands implemented at the avoidance control level.

In embodiments, vehicle control systems 208 may include one or more of (e.g., if the AV 102 is a UAS/UAV) flight control systems, flight management systems, flight surface control systems, autopilot systems, and/or engine/motor/propulsion systems. For example, propulsion may be initiated (e.g., via electric motor, combustion engine, etc.), and flight control surfaces of the AV 102 (e.g., spoilers, flaps, etc.) actuated, such that the AV 102 travels in fulfillment of its assigned default trajectory 108a-108c (or, if necessary, deviates from said default trajectory if the associated control commands are overridden).

In embodiments, the payload 212 and payload control system 210 may include cameras, sensors, munitions, and/or any other like equipment carried by the AV 102 in furtherance of high-level mission goals (e.g., but not necessarily associated with propulsion or steering of the AV) and control interfaces accessible by the mission planning and autonomy stack 216 (e.g., via processors 202) for deploying, implementing, or otherwise controlling the payload. For example (e.g., if the AV 102 is associated with a surveillance-type or search-type mission), the payload 212 may include electro-optical infrared (EO/IR) imaging sensors 218a, radar imaging sensors 218b, and/or passive RF sensors 218c. The EO/IR sensors 218a may include a charge-coupled device (CCD) or CMOS device, may operate in the visual or IR spectral range, and may be configured to generate images of the mission space 104. The radar imaging sensors 218b may transmit signals (e.g., pulses of signals in the RF spectral range), receive reflected return signals, and generate images based on the return signals. The passive RF sensors 218c may detect passive radiation (e.g., black-body radiation) and the characteristics of those emissions may be used to geolocate and identify threats (i.e., without imagery). In embodiments, the combination of EO/IR and radar imaging sensors 218a-218b and passive RF sensors 218c may advantageously provide a redundant system for detecting threats (e.g., in case one or more sensors ceases function).

In embodiments, the images generated by the EO/IR imaging sensors 218a and radar imaging sensors 218b, and/or the emissions detected by the passive RF sensors 218c, may be incorporated by the mission planning and autonomy stack 216 at the mission coordination level to construct an occupancy map (106, FIG. 1) of the mission space 104. For example, the occupancy map 106 (comprising component cells (106a, FIG. 1)) may be a 2D occupancy map (e.g., comprising a plurality of pixels) or a 3D occupancy map (e.g., comprising a plurality of voxels). Further, the mission planning and autonomy stack 216 may, at the mission coordination level, periodically update the occupancy map 106 based on, e.g., progress toward the completion of mission objectives and/or fulfillment of high-level mission goals, and/or the detection and/or identification of adversarial threats, non-objective obstacles (110, FIG. 1), terrain (112, FIG. 1), and/or atmospheric conditions (114, FIG. 1).

In embodiments, the payload 212 may further include any cargo or munitions 220 carried by the AV 102, e.g., either for transport or deployment in furtherance of high-level mission goals and/or specific mission objectives assigned in whole or in part to the AV. For example, a state of the AV 102, as assessed by the mission planning and autonomy stack 216 at the asset level, may include, in addition to a navigational state of the AV, a payload state of the AV (e.g., sensors functional, sensors damaged, sensors inactive, cargo intact, cargo jettisoned, cargo damaged, munitions intact, munitions deployed).

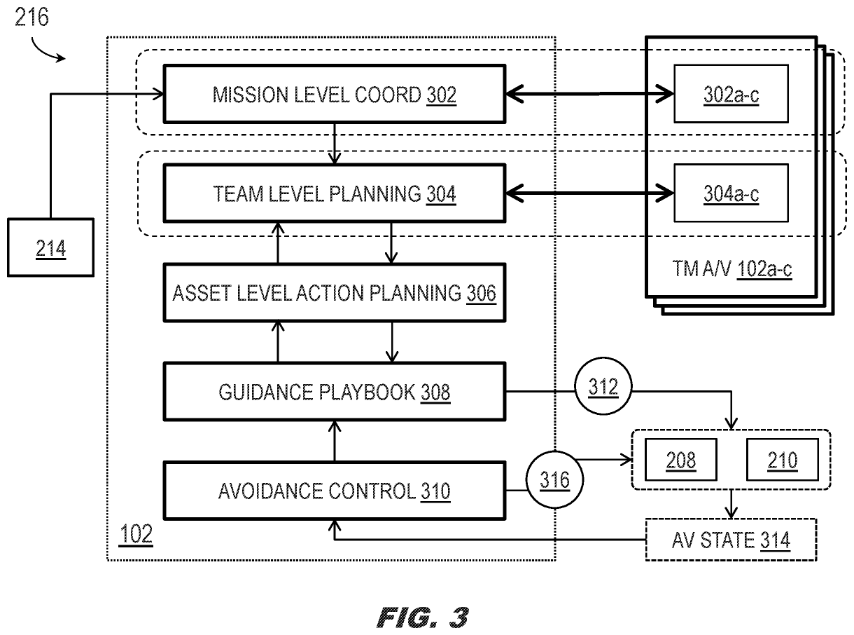

Referring now to FIG. 3, the mission planning and autonomy stack 216 is shown. The mission planning and autonomy stack 216 may be stored to memory (204, FIG. 2) aboard each of the AVs 102, 102a-102d and may include encoded instructions executable by the processors (202, FIG. 2) for implementing the mission planning and autonomy system aboard each member of the AV team (100, FIG. 1). The mission planning and autonomy stack 216 may include one or more layers, e.g.: a mission-level coordination module 302; a team planning module 304; an asset-level action planning module 306; an asset-level guidance playbook module 308; and an avoidance control module 310. In some embodiments, the mission planning and autonomy stack 216 may swap out or combine layers depending on the required level of functionality.

In embodiments, the mission planning and autonomy stack 216 may be a hierarchical system incorporating multiple stacked layers, with data being passed both “downstream” (e.g., from mission-level to asset-level), “upstream” (e.g., from asset-level to mission-level), and “laterally” (e.g., between the AV 102 and teammate AVs 102a-102c at the mission and team planning levels). For example, the mission-level coordination module 302 and team-level planning module 304 may (e.g., via communications devices (206, FIG. 2) share mission-level and team-level mission data 214 (e.g., mission instructions and other received mission data, mission-level objectives, team-level objective and/or sub-team assignments) with counterpart mission-level coordination modules 302a-c and team-level planning modules 304a-c within the mission planning and autonomy stacks 216 aboard teammate AVs 102a-102c.

In embodiments, the mission-level coordination module 302 may receive mission data 214, e.g., high-level mission goals to be executed by the AV team 100 at its autonomous discretion. For example, based on the received mission data 214, the mission-level coordination module 302 (e.g., independently or in collaboration with counterpart mission-level counterpart modules 302a-302c) may spawn specific mission objectives toward the fulfillment of the received high-level mission goals (e.g., through event and request driven API). In embodiments, the mission-level counterpart module 302 may further generate an occupancy map (106, FIG. 1) and coordinate synchronized updates to the occupancy map to track the progress of the AV team 100 toward fulfillment of each mission objective.

In embodiments, the team-level planning module 304 may receive mission objectives spawned by the mission-level coordination module 302 and perform (e.g., independently or in collaboration with counterpart team-level planning modules 304a-304c aboard teammate AVs 102a-102c) team-level planning to allocate mission objectives (and sequences thereof) to specific members of the AV team 100 (e.g., individual AVs 102, 102a-102c or sub-teams of the AV team) and coordinate planning between team members and sub-teams to ensure allocated mission objectives are completed. In some embodiments, the team-level planning module 304 may receive asset-level feedback indicative of a contingency affecting a member AV or sub-team of the AV team 100. For example, contingencies may be associated with an addition to, or attrition from, the AV team 100 (e.g., the attrition of teammate AV 102c and addition of supplementary AV (102d, FIG. 1)). In embodiments, the team-level planning module 304 may inform the mission-level coordination module 302 if a change in overall mission objectives is necessary, or may re-plan current mission objectives among a recomposed AV team 100. For example, team-level planning and/or replanning may be sufficiently robust as to occur in real time or near real time, e.g., at a minimum planning rate of 1 Hz.

In embodiments, the asset-level action planning module 306 may receive specific mission objectives assigned to the AV 102 (e.g., either in whole or in part, i.e., as a member of a sub-team) and may generate optimal guidance and action sequences (e.g., drawn from the asset-level guidance playbook 308 bank of plays, or control actions) for implementing the assigned mission objectives. For example, the set of mission objectives received by the asset-level action planning module 306 may provide for an end state of each member of the AV team 100, e.g., at the terminus of its respective default trajectory 108a-108c with any associated mission payload (212, FIG. 2) deployed (e.g., munitions delivered, territory surveilled, intelligence collected). In embodiments, each asset-level planning module 306 may generate one or more guidance and action sequences, e.g., default trajectories 108a-108c for the teammate AVs 102a-102c, that when implemented cause the embodying AV to overfly any required component cells (106a, FIG. 1) of the occupancy map (106, FIG. 1), e.g., at a desired altitude and/or airspeed, and deploy payload sensors (218a-218c, FIG. 2) as required to perform the surveillance operations associated with completion of the assigned mission objectives. For example, if the AV 102 is performing in a supervisory and/or coordinating role to the teammate AVs 102a-102c performing active surveillance within the mission space (104, FIG. 1), the asset-level planning module 306 aboard the AV 102 may generate guidance and action sequences for maneuvering the AV 102 to locations associated with optimal connectivity and comms operations with all teammate AVs 102a-102c, such that the AV 102 can (e.g., via its mission-level coordination module 302) coordinate synchronized updates to the occupancy map 106.

In embodiments, the asset-level guidance playbook module 308 may receive default trajectories 108a-108c and/or guidance and action sequences generated by the asset-level action planning module 306 and may draw from its onboard bank of plays, maneuvers, and other like action sequences (e.g., rendezvous, holding pattern, maintain comms, pursue target, waypoint following, formation flying) to provide direct control of the AV 102 and/or any associated payload 212 by issuing high-rate control commands 312 to, e.g., the vehicle control and/or payload control systems 208, 210 of the AV 102. For example, control commands 312 may be issued in real time or near real time (e.g., at an optimal frequency of 20 Hz) to cause the vehicle control system 208 of the AV 102 to maintain or adjust one or more of: airspeed, heading, altitude, acceleration rate, climb/descent rate. Similarly, control commands 312 may be issued to cause the payload control system 210 to deploy associated payload 212 aboard the AV 102 (e.g., sensors 218a-218c, munitions 220) in furtherance of the assigned mission objectives and guidance and action sequences generated by the asset-level action planning module 306.

In embodiments, the avoidance control module 310 may continuously monitor the evolving state 314 of the AV 102 as it proceeds along its default trajectory (108a-108c), detecting any threats or constraints not provided for by mission data 214. For example, the avoidance control module 310 may incorporate a variety of monitors (e.g., peer collisions, threatened component cells 106a of the occupancy map 106, keep-in zones, keep-out zones, terrain 112, proximate air vehicles 120) arbitrated according to priorities set by configuration preferences applied to the AV 102 by the received mission data 214. In embodiments, if an imminent threat or constraint is sufficiently urgent, the avoidance control module 310 may issue overrides 316 to the control commands 312 issued by the asset-level guidance playbook module 308 in order to provide short-term steering to avoid, evade, or otherwise resolve any detected threats or constraints. For example, the avoidance control module 310 may issue overrides 316 only when absolutely necessary to do so (e.g., as determined by configuration preferences applied to the AV 102) and in a minimally disruptive manner so as not to interfere with long-term team-level planning or mission objectives. In embodiments, the avoidance control module 310 may provide upstream feedback, e.g., at the asset level or to the team-level planning module 304 and/or mission-level coordination module 302, in order that any asset-level integration, team-level planning, and/or mission-level objectives may be adjusted in light of any overrides 316.

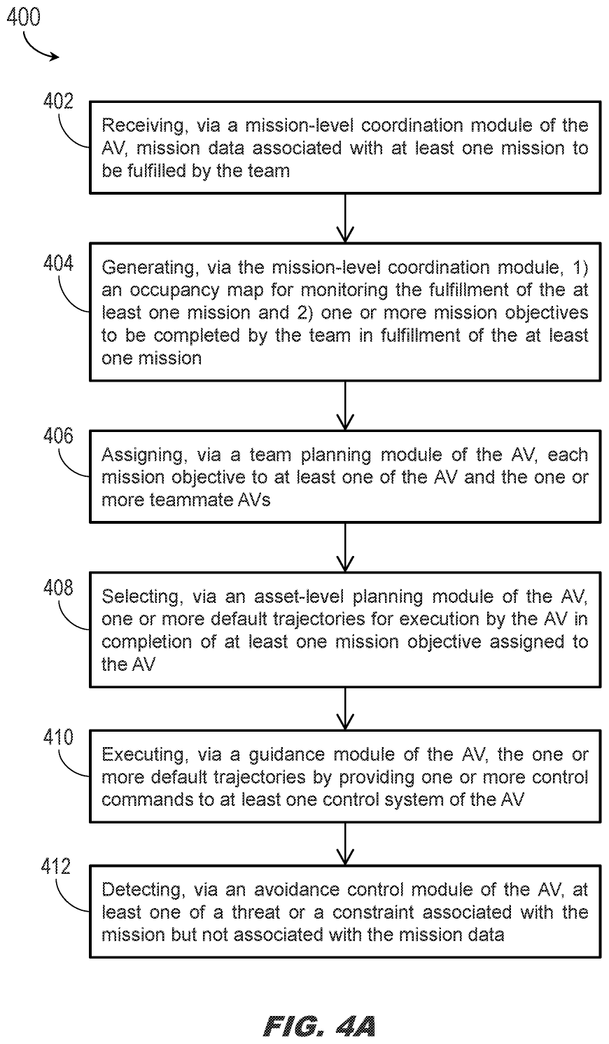

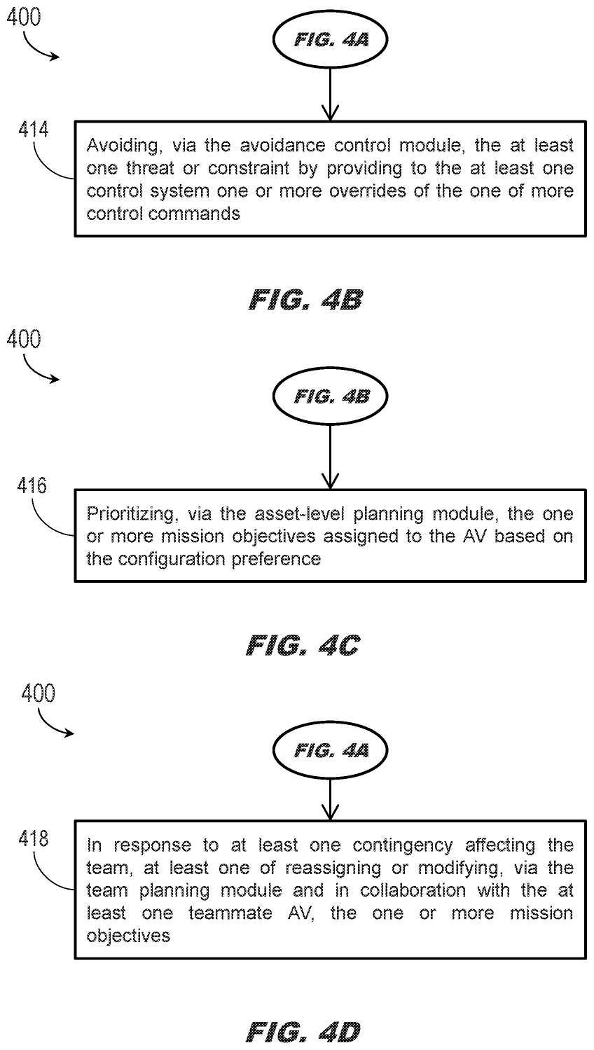

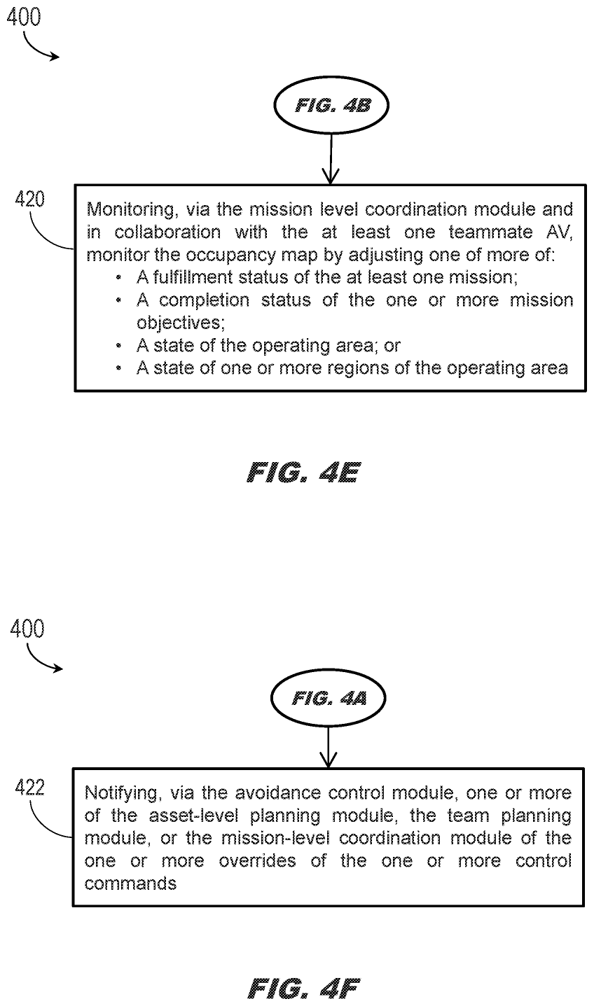

Referring to FIG. 4A, the method 400 may be implemented by the mission planning and autonomy stack 216 aboard the AV 100 and may incorporate the following steps.

At a step 402, a mission-level coordination module of an AV of the AV team (e.g., either independently or in collaboration with teammate AVs) receives mission data incorporating high-level mission goals for one or more missions to be fulfilled by an AV team (e.g., an ownship AV and one or more teammate AVs).

At a step 404, the mission-level coordination module (e.g., either independently or in collaboration with teammate AVs) generates mission objectives to be completed by the AV team in furtherance of the high-level mission goals and an occupancy map for monitoring the progress of mission objective completion and/or mission goal fulfillment.

At a step 406, a team-planning module of the AV (e.g., either independently or in collaboration with teammate AVs) assigns mission objectives to specific member AVs of, or sub-teams within, the AV team.

At a step 408, an asset-level action planning module of the AV selects action and guidance sequences (e.g., default trajectories) for execution by the AV in order to complete its assigned mission objectives. For example, default trajectories may include both flight maneuvers (e.g., for airborne AVs) and payload deployments.

At a step 410, an asset-level guidance playbook module of the AV implements the default trajectories by issuing high-rate flight control and/or payload control commands to control systems of the AV.

At a step 412, an asset-level avoidance control module of the AV detects a threat or constraint not accounted for by the mission data.

Referring also to FIG. 4B, at a step 414 the avoidance control module avoids or evades the threat or constraint by issuing overrides of the high-rate control commands.

Referring now to FIG. 4C, the method 400 may include an additional step 416. At the step 416, the asset-level planning module prioritizes one or more mission objectives based on configuration preferences applied to the AV by the mission data.

Referring now to FIG. 4D, the method 400 may include an additional step 418. At the step 418, the team planning module (e.g., either independently or in collaboration with teammate AVs) reassigns or modifies mission objectives (e.g., or reconfigures the AV team or sub-teams thereof) in response to a detected contingency affecting the AV team.

Referring now to FIG. 4E, the method 400 may include an additional step 420. At the step 420, the mission-level coordination module (e.g., either independently or in collaboration with teammate AVs) monitors the occupancy map, e.g., by monitoring or adjusting: fulfillment status of ongoing mission goals; completion status of assigned mission objectives; states of the operating area (e.g., mission space); and/or states of regions within the operating area.

Referring now to FIG. 4F, the method 400 may include an additional step 422. At the step 422, the avoidance control module notifies asset-level, team-level, and/or mission-level modules upstream of any overrides to issued control commands.

### CONCLUSION

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. A vehicle-based mission planning and autonomy system for multi-asset collaborative operations, comprising:
at least one controller embodied in an autonomous vehicle (AV), wherein the AV is a member of a team comprising the AV and at least one teammate AV, each teammate AV including a like controller and a communications system for information sharing among the members of the team,
the at least one controller operatively coupled with one or more control systems of the AV, the one or more control systems selected from a vehicle control system, the communications system, or a payload control system;
the at least one controller comprising:
one or more processors;
a memory configured for storage of:
mission data associated with at least one mission to be fulfilled by the team;
and
one or more processor-executable program instructions;
and
a hierarchical mission planning and autonomy stack configured for execution of the one or more processor-executable program instructions, the mission planning and autonomy stack comprising:
a mission-level coordination module configured to:
receive one or more mission commands associated with the at least one mission;
and
based on the one or more received mission commands, generate 1) an occupancy map for monitoring the fulfillment of the at least one mission; and 2) one or more mission objectives for completion by the team;
a team planning module configured to assign the one or more mission objectives to the members of the team for completion;
an asset-level planning module configured to, based on the one or more mission objectives assigned to the AV, select at least one default trajectory for execution by the AV;
a guidance and control module configured to:
execute the at least one default trajectory by providing one or more control commands to the one or more control systems, the one or more control commands associated with a minimum command rate;
and
an avoidance control module configured to:
monitor a current state of the AV;
detect, based on the current state, at least one threat not associated with the mission data;
and
in response to the at least one detected threat, modify the at least one default trajectory by overriding at least one control command.

2. The vehicle-based mission planning and autonomy system of claim 1, wherein each of the AV and the at least one teammate AV is selected from a group including an aircraft, a water-based vehicle, and a ground-based vehicle.

3. The vehicle-based mission planning and autonomy system of claim 1, wherein the one or more mission commands include one or more of a mission type, a size of the team, an operating area comprising one or more regions, a feature of the operating area, or a configuration preference associated with the one or more control systems.

4. The vehicle-based mission planning and autonomy system of claim 3, wherein the configuration preference includes a prioritization of the one or more mission objectives assigned to the AV.

5. The vehicle-based mission planning and autonomy system of claim 3, wherein the mission level coordination module is configured to, based on the occupancy map and in collaboration with the at least one teammate AV, monitor the occupancy map by adjusting one of more of:
a fulfillment status of the at least one mission;
a completion status of the one or more mission objectives;
a state of the operating area;
or
a state of one or more regions of the operating area.

6. The vehicle-based mission planning and autonomy system of claim 5, wherein the team is a first team, and the mission-level coordination module is configured to monitor the occupancy map in collaboration with at least one second team of two or more AVs.

7. The vehicle-based mission planning and autonomy system of claim 1, wherein the team planning module is configured for, in collaboration with the at least one teammate AV, at least one of reassigning or modifying the one or more mission objectives in response to at least one contingency affecting the team.

8. The vehicle-based mission planning and autonomy system of claim 1, wherein the one or more control commands cause the vehicle control system of the AV to adjust one or more of a heading of the AV, an altitude of the AV, a velocity of the AV, a climb rate of the AV, or a descent rate of the AV.

9. The vehicle-based mission planning and autonomy system of claim 1, wherein the one or more control commands cause the payload control system of the AV to adjust at least one payload of the AV.

10. The vehicle-based mission planning and autonomy system of claim 9, wherein the at least one payload is selected from a group including:
a camera configured for collection of one or more images;
a sensor configured for detection of one or more radio frequency (RF) emissions;
or
a munition configured for deployment.

11. The vehicle-based mission planning and autonomy system of claim 1, wherein the at least one detected threat is selected from a group including an adversarial structure, an adversarial vehicle, or an adversarial weapon.

12. The vehicle-based mission planning and autonomy system of claim 1, wherein the avoidance control module is configured for overriding the at least one control command based on a detected threat selected from a group including a potential collision, a keep-in zone, or a keep-out zone.

13. A method for vehicle-based multi-asset autonomous collaborative operations among a team including an autonomous vehicle (AV) and one or more teammate AVs, the method comprising:
receiving, via a mission-level coordination module of the AV, mission data associated with at least one mission to be fulfilled by the team;
generating, via the mission-level coordination module, 1) an occupancy map for monitoring the fulfillment of the at least one mission and 2) one or more mission objectives to be completed by the team in fulfillment of the at least one mission;
assigning, via a team planning module of the AV, each mission objective to at least one of the AV and the one or more teammate AVs;
selecting, via an asset-level planning module of the AV, one or more default trajectories for execution by the AV in completion of at least one mission objective assigned to the AV;
executing, via a guidance module of the AV, the one or more default trajectories by providing one or more control commands to at least one control system of the AV;
detecting, via an avoidance control module of the AV, at least one of a threat or a constraint associated with the mission but not associated with the mission data;
and
avoiding, via the avoidance control module, the at least one threat or constraint by providing to the at least one control system one or more overrides of the one of more control commands.

14. The method of claim 13, wherein receiving, via a mission-level coordination module of the AV, mission data associated with at least one mission to be fulfilled by the team includes:
receiving one or more mission commands selected from a group including: a mission type, a size of the team, an operating area comprising one or more regions, a feature of the operating area, a feature of at least one region, or a configuration preference associated with the one or more control systems.

15. The method of claim 14, further comprising:
prioritizing, via the asset-level planning module, the one or more mission objectives assigned to the AV based on the configuration preference.

16. The method of claim 14, further comprising:
monitoring, via the mission level coordination module and in collaboration with the at least one teammate AV, the occupancy map by adjusting one of more of:
a fulfillment status of the at least one mission;
a completion status of the one or more mission objectives;
a state of the operating area;
or
a state of one or more regions of the operating area.

17. The method of claim 13, further comprising:
in response to at least one contingency affecting the team, at least one of reassigning or modifying, via the team planning module and in collaboration with the at least one teammate AV, the one or more mission objectives.

18. The method of claim 13, further comprising:
notifying, via the avoidance control module, one or more of the team planning module, the asset-level planning module, or the mission-level coordination module of the one or more overrides of the one or more control commands.

19. The method of claim 13, wherein executing, via a guidance module of the AV, the one or more default trajectories by providing one or more control commands to at least one control system of the AV includes:
adjusting, via the one or more control commands, wherein the one or more control commands cause a vehicle control system of the AV to adjust one or more of a heading of the AV, an altitude of the AV, a velocity of the AV, a climb rate of the AV, or a descent rate of the AV.

20. The method of claim 13, wherein:
detecting, via an avoidance control module of the AV, at least one of a threat or a constraint associated with the mission but not associated with the mission data includes detecting at least two threats or constraints;
and wherein
avoiding, via the avoidance control module, the at least one threat or constraint by providing to the at least one control system one or more overrides of the one of more control commands includes:
selecting, via the avoidance control module, at least one high priority threat or constraint;
and
avoiding the at least one high priority threat or constraint by providing to the at least one control system one or more overrides of the one or more control commands.
